(19) United States
(12) Patent Application Publication
(10) Pub. No.: US 2008/0084544 A1
(43) Pub. Date: Apr. 10, 2008

(54) Discrete High Switching Rate Illumination Geometry For Single Imager Microdisplay

(76) Inventors: Estill Thone Hall, Fishers, IN (US); James Edward Lyst, Indianapolis, IN (US); Eugene Murphy O'Donnell, Fishers, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/632,744

(22) PCT Filed: Jul. 22, 2004
(86) PCT No.: PCT/US04/23648

§ 371 Date: Jan. 18, 2007

(51) Int. Cl. F21V 13/00

(52) U.S. Cl. 353/33; 353/31

(57) ABSTRACT

A projection system is provided, comprising three discrete monochromatic light sources for sequentially providing monochromatic beams of blue, green and red light to a single imager, which modulates the light on a pixel-by-pixel basis to form a matrix of modulated light pixels. Each of the monochromatic light sources has a switching rate consistent with a refresh rate of the projection system for generating sequential, discrete monochromatic beams of light. The monochromatic matrices of modulated light are combined to form a full color viewable image.

### FIELD OF THE INVENTION

The invention relates to a projection system and more particularly to a projection system using discrete monochromatic high switching-rate light sources with a single imager microdisplay.

### BACKGROUND OF THE INVENTION

Microdisplays are increasingly used for projecting images in display applications, such as rear projection televisions. For color projection systems, one or more imagers of a microdisplay modulate a monochromatic light input on a pixel-by-pixel basis to form a modulated matrix of light pixels. Then, three monochromatic modulated matrices of light are combined on a screen or diffuser to form a viewable color image. The monochromatic imaging may be achieved by separating a white light source into three monochromatic light beams and using three separate imagers to modulate the separate monochromatic light beams, called multiple imager microdisplays. Using three separate imagers in a microdisplay projection system, however, can be expensive.

Alternatively, a white light source may be temporally separated into monochromatic light beams by a color wheel, for example, so that separate monochromatic light beams are modulated sequentially by a single imager. Because of the speed at which the light color is changed, the sequential colors are blended by the eye to create a color image. The color wheel for temporally separating light can also be expensive. Additionally, transmission efficiency of the light is adversely affected when the light beam is on a spoke separating the different color filters of the color wheel. Single imager microdisplay projection systems also provide poor power efficiency, since the majority of light being produced at any given time is filtered out by the color wheel.

A resonant microcavity architecture (RMA) device for modifying the wavelength of a spontaneous light emission is known for example from U.S. Pat. Nos. 5,804,919 and 5,955,839. These devices reabsorb light that is outside of the desired range of wavelengths, thereby emitting only light in a desired range of wavelengths, while reducing the total power consumption.

### SUMMARY OF THE INVENTION

A system is proposed for using three discrete, rapidly switching light sources to make an illumination system for a single imager microdisplay device. In an exemplary embodiment of the invention, a projection system is provided, comprising three discrete monochromatic light sources for sequentially providing monochromatic beams of blue, green and red light to a single imager. Each of the monochromatic light sources has a switching rate consistent with a refresh rate of the projection system for generating sequential, discrete monochromatic beams of light. The single imager modulates each monochromatic beam of light on a pixel-by-pixel basis to form a matrix of modulated light pixels. The monochromatic matrices of modulated light are combined to form a full color viewable image.

### BRIEF DESCRIPTION OF THE DRAWINGS

The invention will be described with reference to the accompanying drawings, of which:

FIG. 1 is a block diagram of a projection system using discrete, high switching-rate illumination sources with a single imager according to an exemplary embodiment of the invention; and

FIG. 2 shows the paths of monochromatic light beams generated by the three discrete, high switching-rate illumination sources according to an exemplary embodiment of the invention.

### DETAILED DESCRIPTION OF THE INVENTION

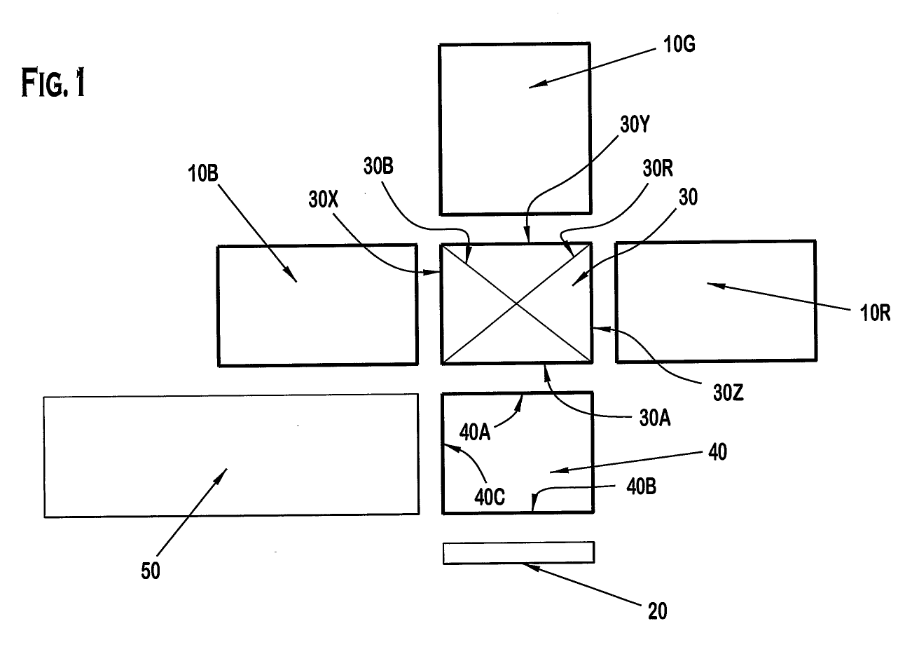

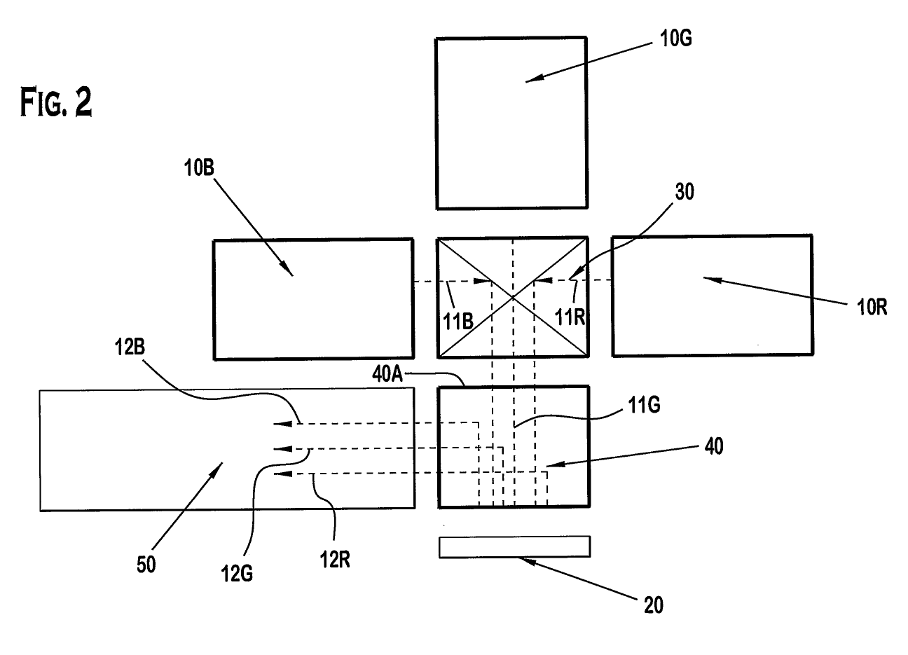

FIGS. 1 and 2 show a projection system according to an exemplary embodiment of the invention. Three monochromatic light sources 10B, 10G, and 10R emit monochromatic light beams 11B, 11G, 11R in the blue, green and red color spectrums, respectively. In the illustrated example, the monochromatic light sources 10B, 10G, 10R are Resonant Microcavity Architecture (RMA) devices. The monochromatic light sources 10B, 10G, 10R are sequentially switched on, such that at any point in time, only one of the three monochromatic light sources is switched on. Thus, while FIG. 2 shows all three monochromatic light beams 11B, 11G, 11R for convenience, no more than one of the three light beams will be generated at any particular time. The monochromatic light sources 10B, 10G, 10R have a high switching rate such that they can each be cycled on during a single refresh cycle for a display employing the exemplary projection system. For example, an exemplary liquid crystal display television or DLP display television with a UHP lamp and using sequential color has a color change rate (RGBRGB, etc) of about 2 to 6 cycles per video frame. This color change rate or cycling rate is restricted by physical color wheel speed and the necessity of pulsing the lamp for arc stabilization. Fast cycling rates cause rapid deterioration of the lamp life and slow cycling rates leave visible sequential color artifacts. The monochromatic light sources 10B, 10G, 10R can be cycled in a few microseconds, without rapidly deteriorating their life. Thus, using the monochromatic light sources 10B, 10G, 10R allows for many more cycles per video frame, and thus reduces the possibility of sequential color artifacts.

The three monochromatic light sources 10B, 10G, 10R are aligned with three faces 30X, 30Y and 30Z of an X-cube 30. An exemplary X-cube is available from Unaxis of Golden, Colo. or JDS Uniphase of Santa Rosa, Calif. The X-cube 30 has two selectively reflective surfaces 30B, 30R which are mutually perpendicular and are both at a 45 degree angle to the beams of light from each of the three monochromatic light sources 10B, 10G, 10R. The selectively reflective surfaces 30B, 30R allow light in most color spectrums to pass through, while reflecting light in a specific color spectrum. The selectively reflective surface 30B, for example, reflects light in the blue color spectrum, while allowing light in the green and red color spectrums to pass through it. The selectively reflective surface 30R, in contrast, reflects light in the red color spectrum, while allowing light in the blue and green color spectrums to pass through it.

In the projection system of FIG. 1, a p-polarized light beam 11G in the green color spectrum is generated by the green monochromatic light source 10G, aligned with a surface 30Y of the X-cube 30. The green light beam 11G enters the surface 30Y and passes through both of the selectively reflective surfaces 30B, 30R of the X-cube 30, exiting through a surface 30A of the X-cube 30 that is disposed opposite the surface 30Y. The blue monochromatic light source 10B is disposed in alignment with a surface 30X of the X-cube. A p-polarized light beam 11B in the blue color spectrum is generated by the blue monochromatic light source 10B. The blue light beam 11B enters the X-cube 30 through surface 30X and is reflected at a right angle by selectively reflective surface 30B, exiting the X-cube 30 through surface 30A. It should be noted that a portion of the blue light beam 11B is incident upon the selectively reflective surface 30R, but since selectively reflective surface 30R only reflects light in the red color spectrum, this blue light passes through selectively reflective surface 30R. The red monochromatic light source 10R is disposed in alignment with a surface 30Z of the X-cube. A p-polarized light beam 11R in the red color spectrum is generated by the red monochromatic light source 10R. The red light beam 11R enters the X-cube 30 through surface 30Z and is reflected at a right angle by selectively reflective surface 30R, exiting the X-cube 30 through surface 30A. It should be noted that a portion of the red light beam 11R is incident upon the selectively reflective surface 30B, but since selectively reflective surface 30B only reflects light in the blue color spectrum, this red light passes through selectively reflective surface 30B.

From the foregoing description, it should be understood, that each monochromatic light beam from the three monochromatic light sources 10B, 10G, 10R exit the X-cube 30 through surface 30A. In an exemplary embodiment of the invention, the monochromatic light sources 10B, 10G, 10R are disposed at equal distances from the center of the X-cube 30, such that the three monochromatic light beams travel an equal distance. This will facilitate sequential timing, as will be discussed below.

An imager-input cube 40 is disposed proximate the source 30A through which each of the three monochromatic light beams exit the X-cube 30. The imager-input cube 40 is disposed such that the monochromatic light beams 11B, 11G, 11R enter a surface 40A facing the X-cube 30 and exit a surface 40B facing a single imager 20. The imager 20 may be a Liquid Crystal On Silicon (LCOS) imager or a Digital Light Pulse (DLP) imager. The imager-input cube 40 is matched to the imager 20. Thus, if, as in the illustrated embodiment, the imager 20 is a LCOS imager, then the imager-input cube 40 is a Polarizing Beam Splitter (PBS). Conversely, if the imager 20 is a DLP imager, then the imager-input cube 40 is a Total Internal Reflection (TIR) prism. As will be understood by those skilled in the art, the monochromatic light beams 11B, 11G, 11R are directed by the imager-input cube 40 into the imager 20. The single imager 20 modulates the monochromatic light beams 11B, 11G, 11R on a pixel-by-pixel basis to form a matrix or array of modulate light pixels 12B, 12,G, 12R for each color beam. The matrices of modulate light pixels 12B, 12,G, 12R are directed by the imager-input cube 40 through a surface 40C and into a projection lens 50. The monochromatic matrices of modulated light are projected by the projection lens 50 onto a screen (not shown) where they are combined by the eye of a viewer to form a full color viewable image.

The three monochromatic light sources 10B, 10G, 10R are sequentially switched on by a control system (not shown). The control system synchronizes the light sources so that when one of the light sources is switched on, the other two light sources are off. The light sources are sequentially switched on, allowing a single imager 20 to modulate each of the three monochromatic light beams 11B, 11G, 11R.

While illustrated and described with reference to using RMA devices for light sources 10B, 10G, 10R, alternative embodiments are contemplated using light emitting diodes or laser diode arrays as light sources 10B, 10G, 10R. For these alternate embodiments, relay systems will be used to switch the light emitting diodes or laser diode arrays on and off.

One advantage of a projection system according to the invention is that the three monochromatic light sources 10B, 10G, 10R can be turned “on” or “off” very rapidly, and thus electronics can be used to produce sequential color (instead of mechanical means, or fairly slow (and inefficient) liquid crystal (LC) transitions. Also, there is a power advantage, since the light beams from each of these sources is in very narrow band of color or wavelength, and thus less power is wasted in unwanted wavelengths of light. Only light having wavelengths in the three primary colors (blue, green, and red) is generated.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A projection system, comprising:
at least three monochromatic light sources, each having a switching rate consistent with a refresh rate of the projection system for generating monochromatic beams of light in the blue, red and green color spectrums; and
a single imager for modulating the monochromatic beams of light on a pixel-by-pixel basis to form a matrix of modulated light pixels.

2. The projection system of claim 1, wherein control electronics sequentially switch on the at least three monochromatic light sources.

3. The projection system of claim 1, further comprising an X-cube for directing each of the monochromatic beams of light from the three monochromatic light sources toward the imager.

4. The projection system of claim 3, further comprising an imager input cube for directing the monochromatic beams of light into the imager and directing the matrix of modulated light pixels into a projection lens.

5. The projection system of claim 4, wherein the imager is a DLP imager and the imager input cube is a TIR prism.

6. The projection system of claim 4, wherein the imager is an LCOS imager and the imager input cube is a polarizing beam splitter.

7. The projection system of claim 1, wherein the monochromatic light sources are Resonant Microcavity Architecture (RMA) devices.

8. The projection system of claim 1, wherein the monochromatic light sources are light emitting diodes.

9. The projection system of claim 1, wherein the monochromatic light sources are laser diode arrays.

10. A display apparatus comprising:
at least three monochromatic light sources having a switching rate consistent with a refresh rate of the projection system for generating monochromatic beams of light in the blue, red and green color spectrums;
an imager for modulating the monochromatic beams of light on a pixel-by-pixel basis to form a matrix of modulated light pixels;
an imager input cube for directing the monochromatic beams of light into the imager and directing the matrix of modulated light pixels into a projection lens; and
an X-cube for directing each of the monochromatic beams of light from the at least three monochromatic light sources into the imager input cube.

11. The display apparatus of claim 10, wherein a controller sequentially switches on the at least three monochromatic light sources.

12. The display apparatus of claim 10, wherein the imager is a DLP imager and the imager input cube is a TIR prism.

13. The display apparatus of claim 10, wherein the imager is an LCOS imager and the imager input cube is a polarizing beam splitter.

14. The display apparatus of claim 10, wherein the monochromatic light sources are Resonant Microcavity Architecture devices.

15. The display apparatus of claim 10, wherein the monochromatic light sources are light emitting diodes.

16. The display apparatus of claim 10, wherein the monochromatic light sources are laser diode arrays.
